(19) United States
(12) Patent Application Publication
(10) Pub. No.: US 2005/0061412 A1
(43) Pub. Date: Mar. 24, 2005

(54) Elastomeric semifinished product for the production of a tyre liner and type provided with said liner

(76) Inventors: Rodolfo Noto, Gorgonzola (IT); Ignazio De Gese, Sesto San Giovanni (IT); Gaetano Lo Presti, Sesto San Giovanni (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/498,000

(22) PCT Filed: Dec. 19, 2001
(86) PCT No.: PCT/IT01/00641

(51) Int. Cl. B29D 30/00; B60C 5/12

(52) U.S. Cl. 152/510; 156/117; 428/156

(57) ABSTRACT

A semi-finished product of elastomeric material includes a strip suitable for manufacturing an inner gas-impermeable coating layer of a pneumatic tyre. A right cross-section of the strip includes a profile that tapers axially outwards on at least one edge of the strip. A method for manufacturing a tyre for a vehicle wheel includes forming a layer of liner on a rigid support by laying at least one strip of elastomeric material on the rigid support in axially consecutive turns, laying other semi-finished products suitable for forming other components of the tyre in a radially outer position with respect to the layer of liner, and vulcanizing the layer of liner and other semi-finished products. The at least one strip includes a right cross section including the tapered profile. A tapered portion of a first turn is axially overlapped on an axially adjacent turn that was previously laid on the rigid support.

The present invention relates to a semi-finished product of elastomeric material, especially in the form of a thin elongated strip, preferably of constant thickness, hereinafter referred to as a strip, which is intended to be used in the manufacture of rubber articles, possibly in combination with other semi-finished products, for example the rubber-coated cords as such or the so-called bands, that is strips of elastomeric material incorporating reinforcing cords. More particularly, the rubber semi-finished products mentioned above are preferably used in a process for the manufacture of a tyre.

In particular, the invention relates to an improved strip which is suitable for manufacturing the gas-impermeable inner coating, hereinafter referred to as a liner, of a pneumatic tyre of the tubeless type, that is one intended to be used without an inner tube.

The invention also relates to a method for manufacturing a tyre for vehicle wheels, in particular a tyre of the tubeless type, in which said gas-impermeable layer, the so-called liner, is manufactured by using said improved strip.

It is also specified that, for the purposes of the present description, the term “elastomeric material”, also alternatively described as “rubber”, relates to a rubber mixture in its entirety, that is the whole comprising at least one polymeric base suitably amalgamated with reinforcing fillers and/or process additives of various kinds.

In general a tyre comprises a toroidally-shaped carcass which includes at least one reinforcing ply, the ends of which are firmly secured to a pair of bead cores in a radially inner position, a tread band surrounding said carcass and a belt structure located between said at least one reinforcing ply and said tread band.

Said belt structure usually comprises at least two radially overlapping plies of rubberized fabric incorporating metal reinforcing cords located in parallel alongside each other in each ply and crossing those of the adjacent ply, preferably in a symmetrical manner with respect to the equatorial plane of the tyre, and may also comprise a reinforcing ply in a radially outer position which incorporates reinforcing cords located substantially parallel to the equatorial plane.

Among the components made of rubber alone which are generally used in the manufacturing processes of a tyre, for example, mention may be made, in addition to the already mentioned air-impermeable layer (liner) which covers the inner surface of tubeless tyres, of the tread band, the sidewalls, the sheet which is located between the tread band and the belt structure, or the sheet which is sometimes placed between two separate belt plies, other strips of restricted width and transversely variable thickness located beneath the ends of the belt structure or the rubber strips, of limited width and constant thickness, which are bent around the ends of the belt plies.

Obtaining the abovementioned components requires, in a preliminary stage, the preparation of a mixture according to a suitable recipe whose ingredients are selected in relation to the particular component which is desired to be obtained.

In older manufacturing processes, each of said components was produced by shaping or drawing, for example by extruding the component in the form of a continuous strip having the final configuration in the right cross section, then winding said strip onto a suitable manufacturing drum, cutting said strip into pieces of the required length and joining the circumferentially opposite ends of said pieces directly on said manufacturing drum.

In particular, the liner layer of a tyre was formed by placing a sheet of a suitable mixture of appropriate width onto the manufacturing drum and joining by overlapping the preferably tapered ends, as for example described in U.S. Pat. No. 5,679,205.

In more recent manufacturing processes particular attention has been paid to finding methods of production which made it possible to eliminate or at least to reduce the manufacture of intermediate. components for the purposes of manufacturing tyres. According to said methods each component is manufactured directly on the manufacturing drum by using a basic semi-finished product of minimum dimensions, preferably the same for each type of tyre, wound onto said drum in turns axially arranged side-by-side and/or radially overlapped, or cut into unit lengths which are laid on said drum consecutively in a circumferential direction. For example, in European patent application EP 97830731.2, in the name of the same Applicant, there is described a method for the manufacture of tyres in which the carcass ply or plies, as well as each of the belt plies, are obtained by laying a plurality of strip-shaped pieces one after the other in a circumferential side-by-side relationship onto a rigid toroidal support shaped in accordance with the inside shape of the tyre which is to be obtained, which has already been covered with a suitable layer of liner. According to said technology, the layer of liner, like every other component made of rubber alone, is formed by winding onto said toroidal support successive turns arranged side-by-side, and possibly radially overlapped, of a suitable strip of elastomeric material.

Vulcanization is performed by placing the toroidal support, bearing the green tyre, in a vulcanization mould in which the tyre is expanded (torically shaped) and pressed against the walls of the cavity containing it by means of a vulcanizing fluid released by the surface of the toroidal support. According to said manufacturing technique, as no vulcanization bladder, which separates the inside surface of the tyre from that of the support, is provided; the vulcanizing fluid, generally steam and/or nitrogen, is caused to directly contact the liner by pressing against its surface at the specified vulcanization pressure, usually of the order of approximately thirty atmospheres. If the turns of the liner mixture have not been laid correctly, and especially if there are gaps or cracks, i.e. if they are not always closely in contact, the vulcanizing fluid can penetrate among the turns and reach the elastomeric mixtures of the other components which are located radially external to the liner with undesired effects, e.g. in particular the absorption of moisture from the vulcanizing fluid, which remains within the elastomeric mixture giving rise to possible corrosion phenomena (for example rust) in the metal reinforcing cords and in general compromising the properties of the structure of the vulcanized tyre.

It has been suggested that the liner layer should be prevulcanized, but said measure is not effective when turns have not been correctly arranged side-by-side and still leave a passage for the fluid since prevulcanizing does not modify an incorrect laying.

It has also been suggested that the turns should be laid with an overlap between two adjacent strips, that is partly overlapping the turns, but said measure results in air bubbles being included between the edge of one strip and the edge of the partly overlapped strip. Furthermore, the liner structure becomes irregular and, lacking the flattening effect of the vulcanizing bladder, transmits said irregularity to the inner surface of the finished tyre which is irregular and unacceptable to users who can detect it easily either visually or by touch.

In accordance with a further technique known in the art, in order to ensure a liner of constant thickness by laying several turns arranged axially side-by-side, it has been suggested that said liner should be constructed in two separate radially overlapping layers so that the turns forming the radially outer layer are laid in corrispondence of the junction zone of the turns forming the radially inner layer. Although ensuring a constant liner thickness and an effective barrier against the passage of the vulcanizing fluid between the turns which are axially arranged side-by-side during the stage of vulcanization or of the inflating gas when the tyre is in operation, said further solution nevertheless has disadvantages associated with greater complication and greater length of the laying process which has to be carried out in two separate steps.

The present invention is designed to overcome or at least to reduce the above-mentioned disadvantages in the prior art. The Applicant has in fact found that by suitably shaping the right cross section of a strip of elastomeric material it has been possible to produce a layer of liner by winding said strip in turns consecutively laid and at least partly overlapped at their end edges, imparting a substantially uniform thickness to said layer despite said overlap.

More particularly, the Applicant has found that by using a strip having a right cross section which is oblong in a transverse direction, that is a right cross section which is approximately oval or elliptical, thick at the centre and progressively tapered towards the edges, laid on a support with its major axis substantially parallel to the axis of rotation of the support, it is possible to overlap the edges of the axially adjacent turns in a way which is sufficient to ensure the elimination of voids or gaps between said turns, simultaneously guaranteeing a minimum thickness of liner layer for the vulcanized tyre, with a substantially smooth and uniform inner surface even if the liner is vulcanized without undergoing the mechanical effect of the pressure of an expandable diaphragm such as a vulcanizing bladder.

In a first aspect the invention is designed to provide a semi-finished rubber product, in particular for the manufacturing of the liner layer of tyres, which makes it possible to overlap the turns of said semi-finished product (strip) while maintaining uniform thickness in the laid layer.

More particularly, the invention relates to a semi-finished product of elastomeric material in the form of a strip which is suitable for producing the inner gas-impermeable coating of a pneumatic tyre of the tubeless type, characterized in that the right cross section of said strip has a profile which tapers axially outwards on at least one of its edges.

Preferably, the right cross section of said strip has a trapezoidal profile. More preferably, said trapezoidal profile is symmetrical with respect to the centre of the cross section.

In another aspect, the invention relates to a method for manufacturing a tyre of the tubeless type for vehicle wheels having a liner layer of uniform thickness which is axially continuous from one end of said tyre to the other.

More particularly the invention relates to a method for manufacturing a tyre of the tubeless type for vehicle wheels comprising the steps of:
forming a layer of liner by laying at least one strip of elastomeric material onto a rigid support in axially consecutive turns,
laying other semi-finished products suitable for forming other components of the tyre in a radially outer position with respect to said layer,
vulcanizing the complex so formed,
   characterized in that it further comprises the steps of:
providing said at least one strip with right cross section having a profile which tapers axially outwards on at least one edge of said strip,
laying said strip on said rigid support, and
overlapping a tapered portion of a turn onto the axially adjacent turn which has previously been laid.

Preferably said laying step provides that said strip is laid onto said rigid support with its larger dimension in contact with said rigid support.

Preferably, said method comprises the step of providing said at least one strip with a right cross section having a trapezoidal profile. More preferably, said trapezoidal profile is symmetrical with respect to the centre of the cross section.

The method according to the invention may also advantageously be used when a vulcanizing chamber of the conventional type provided with an expandable bladder into which the vulcanizing fluid is introduced is used. In accordance with said method the green tyre, once it has been produced, is separated from the above toroidal support and placed within said vulcanizing chamber in the absence of said support.

In accordance with a further aspect, the invention relates to a tyre in which the gas-impermeable layer, i.e. the liner, is manufactured by using turns of a strip having a right cross section which is tapered at the ends.

The invention also relates to a tyre of the tubeless type for vehicle wheels in which the liner layer is manufactured by using a semi-finished product of elastomeric material and a method as specified above.

In accordance with a preferred embodiment, the larger base of the trapezoidal cross section of the strip has dimensions between 10 mm and 25 mm, preferably of about 15 mm, while the smaller base has dimensions of between 1 mm and 10 mm, preferably of about 3 mm.

Furthermore, preferably the maximum thickness of the strip is between 0.6 mm and 3.0 mm, more preferably is between 0.7 mm and 0.9 mm.

In accordance with a further embodiment, the smaller base of the right cross section of the strip according to the invention has a dimension which is substantially close to zero. In this case, therefore, the strip has a right cross section of a substantially triangular shape.

In accordance with a further embodiment, the right cross section of the strip according to the invention has a profile in the shape of a parallelogram or of a rhomboid.

Further features and advantages will be more apparent in the light of the following description of some preferred embodiments of the present invention.

Said description relates to the appended drawings, which are provided solely for explanatory purposes and without any restrictive intent, in which:

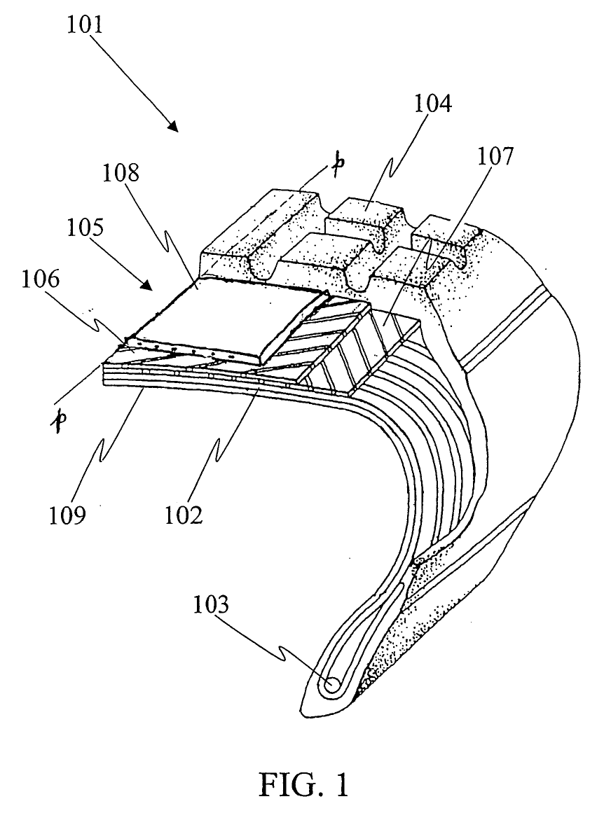

FIG. 1 shows in right cross section the generic structure of a tyre provided with a liner according to the invention;

FIG. 2 shows in a perspective view a portion of a strip according to a preferred embodiment of the invention;

FIG. 3 shows a right cross section of the strip of elastomeric mixture according to FIG. 1, and

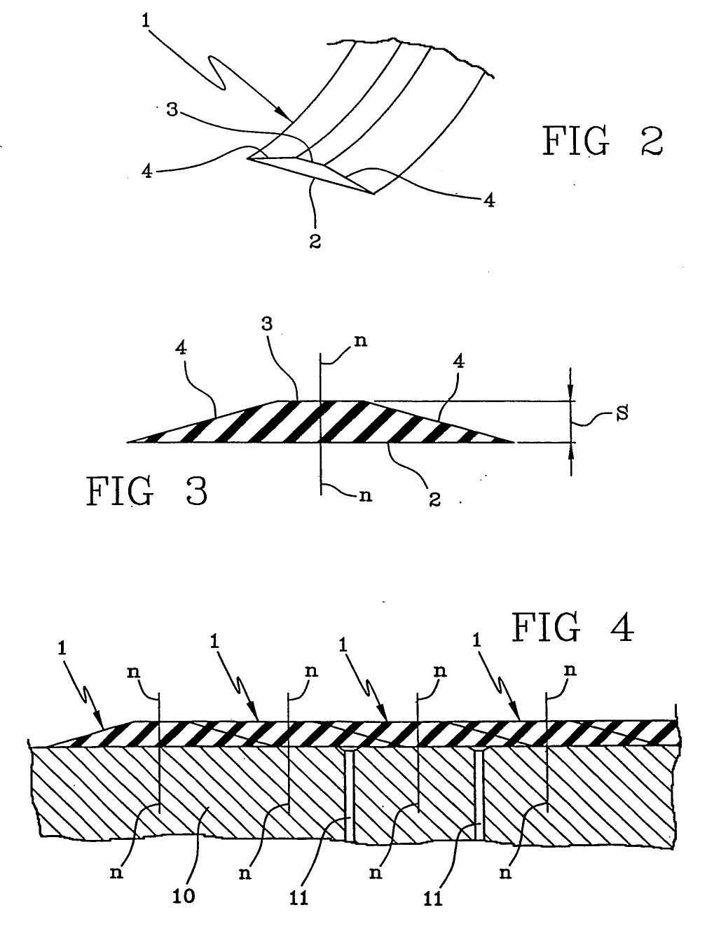

FIG. 4 shows in partial diagrammatical right cross section a rigid support on which some turns of the strip of FIG. 2 have been laid in order to form a liner layer.

A vehicle wheel radial tyre 101 in its most general form comprises an annular carcass of toroidal shape with a tread band and two axially opposite sidewalls which extend radially between said tread band and corresponding radially inner edges of said tyre, usually known as beads, whose purpose is to allow the tyre to be assembled with its corresponding mounting rim.

Said carcass comprises one or more carcass plies 102 reinforced with reinforcing cords lying in radial planes, that is containing the rotation axis of the tyre, and having their own ends associated to two annular metal cores 103, usually known as bead cores, which are the reinforcement of said beads.

Around said carcass is placed a thick layer 104 of elastomeric material, that is the tread band, in which there is made in relief a tread pattern for contacting the road, suitable among other things for ensuring that said tyre provides traction, good mileage, noiseless and regular wear.

Between the carcass and the tread band there is placed an annular reinforcing structure 105, usually known as a belt, circumferentially inextensible, comprising at least two radially overlapping strips 106 and 107 of rubberized fabric provided with metal reinforcing cords located parallel to each other in each layer and crossing those of the adjacent layer, preferably symmetrically arranged with respect to the equatorial plane p-p of the tyre, and preferably also a third layer 108 of reinforcing cords wound circumferentially onto said underlying pair of strips, but in a radially outer position with respect to said belt structure.

In particular, tyre 101 of FIG. 1 is of the so-called “tubeless type”, that is such that it does not require the use of an inner tube when in operation. Therefore, said tyre is provided with a component, known as a “liner”, that is a layer of elastomeric material 109 which is impermeable to air, located on the inner surface of the tyre. The manufacture of said layer of liner is the specific object of the present invention, therefore the tyre is not described in greater detail here in that it is of a type which is well known, and is substantially irrelevant with regard to the invention.

With reference to FIGS. 2 and 3, a strip 1 according to the invention is obtained through the extrusion of a mixture having the property of being impermeable to gases, in particular air. The right cross section of the strip is constant along the longitudinal length of the strip and it has a profile which extends substantially in the axial direction and tapers outwardly on at least one edge. In particular, in the example illustrated, it has a profile of a trapezoidal shape which is symmetrical with respect to the center line n-n of the strip, with a larger base 2, a smaller base 3 and two inclined sides 4.

The thickness of the strip, which is preferably comprised between 0.6 mm and 3.0 mm, and even more preferably between 0.7 mm and 0.9 mm, in this case is of about 0.75 mm.

The larger base 2 of the right cross section of the strip, which is preferably comprised between 10 mm and 25 mm, in this case is approximately 15 mm; the smaller base 3, which is preferably comprised between 1 mm and 10 mm, in this case is of about 3 mm.

With reference to the right cross section shown in FIG. 4, the layer of liner is obtained by winding axially consecutive turns of strip 1 onto a rigid toroidal support 10 by placing the larger base 2 in contact with the support 10 and by laying the axially consecutive turns with partial overlap of the tapered parts. In this way a tapered lateral portion of the strip is laid so as to overlap the tapered lateral portion of the turn which has already been laid; the other laterally tapered portion will in turn be covered by the laterally tapered portion of the next turn. The tapered portions are thin and of green rubber, and are therefore easily deformable; moreover they are overlapped in a complementary way, that is the minimum thickness of the taper of one turn substantially coincides with the maximum thickness of the taper of the adjacent turn, as a result of which the mean thickness of the layer remains substantially constant even in the overlapping tapered portions. The pressure of the vulcanizing fluid which leaves appropriate holes 11 provided in the body of the support creates an intermediate space (not illustrated) between the radially outer surface of the support and the radially inner surface of the liner, and acts within said intermediate space pressing the liner against the tyre carcass ply. In the known art said pressure had the effect of conveying all the surface irregularities created on the outer surface of the liner as a result of laying the turns of partly overlapped strip onto the toroidal support through to the inner surface of the liner and therefore of the vulcanized tyre. By means of the method according to the invention, and of the corresponding strip, the liner thickness is constant along the axial length of the support, despite the overlap between the tapered portions, as a result of which the liner thickness remains constant even when pressed against the carcass ply, conferring a smooth, regular and uniform aspect to the radially inner surface of the tyre.

In the embodiment illustrated, the overlap of the tapered portions is complete, but the overlap can also be partial; this notwithstanding, any errors in alignment or laying of the adjacent turns become negligible given that the overlap of the tapered parts is sufficiently great to prevent the formation of a preferred penetration route for the vulcanization fluid towards the inner structure of the tyre in any circumstances. It should also be noted that the sum of the overlapping fractions of the liner manufactured according to the invention is of the order of 60% of the overall transverse extent of the liner and therefore of sufficient size to amply compensate for any possible inaccuracies in laying and variations in the thickness of the strip due to manufacturing tolerances.

In a further embodiment according to the present invention, the liner can be obtained by arranging a pair of radially overlapping layers in such a way that the larger bases of the axially adjacent turns of the radially outer layer are laid in a position substantially corresponding to the junction zone of the axially adjacent turns of the radially inner layer.

1. Method for manufacturing a tyre for vehicle wheels comprising the steps of:
forming a layer of liner by laying at least one strip of elastomeric material onto a rigid support in axially consecutive turns,
laying other semi-finished products suitable for forming the other components of the tyre in a radially outer position with respect to said layer,
vulcanizing the complex so formed,
characterized in that it further comprises the steps of:
providing said at least one strip with a right cross section having a profile which tapers axially outwards on at least one edge of said strip,
laying said strip on said rigid support, and
overlapping a tapered portion of a turn onto the axially adjacent turn which has previously been laid.

2. Method according to claim 1, in which said laying step provides that said strip is laid onto said rigid support with its larger dimension in contact with said rigid support.

3. Method according to claim 1, characterized in that the tapered portions of two adjacent turns (9) overlap completely in the transverse direction.

4. Semi-finished product of elastomeric material in the shape of a smooth strip or strip (1), suitable for the manufacturing of the inner gas-impermeable coating layer of a pneumatic tyre, characterized in that the right cross section of said semi-finished product has a profile which tapers axially outwards on at least one edge.

5. Semi-finished product according to claim 4, characterized in that the right cross section of said semi-finished product has a trapezoidal profile.

6. Semi-finished product according to claim 5, characterized in that said trapezoidal profile is symmetrical with respect to the centre of said cross section.

7. Semi-finished product according to claim 5, characterized in that the larger base (2) of said trapezoidal cross section is of dimensions comprised between 10 mm and 25 mm.

8. Semi-finished product according to claim 5, characterized in that the smaller base (3) of said trapezoidal cross section is of dimensions comprised between 1 mm and 10 mm.

9. Semi-finished product according to claim 4, characterized in that the thickness of said strip (1) is between 0.6 mm and 3.0 mm.

10. Tubeless tyre for vehicles comprising a liner layer manufactured by using a semi-finished product of an elastomeric mixture in the form of a thin (1) in accordance with any one of claims 4 to 9.

11. Tubeless tyre for vehicles comprising a layer of liner manufactured by using the method according to any one of claims 1 to 3.

1-11. (canceled)

12. A method for manufacturing a tyre for a vehicle wheel, comprising:
forming a layer of liner on a rigid support;
laying other semi-finished products in a radially outer position with respect to the layer of liner; and
vulcanizing the layer of liner and the other semi-finished products;
wherein the layer of liner is formed by laying at least one strip of elastomeric material on the rigid support in axially consecutive turns,
wherein the other semi-finished products are suitable for forming other components of the tyre,
wherein the at least one strip comprises a right cross section comprising a profile that tapers axially outwards on at least one edge of the at least one strip, and
wherein a tapered portion of a first turn is axially overlapped on an axially adjacent turn that was previously laid on the rigid support.

13. The method of claim 12, wherein the at least one strip is laid on the rigid support with a larger dimension of the at least one strip in contact with the rigid support.

14. The method of claim 12, wherein tapered portions of two axially adjacent turns overlap completely in a transverse direction.

15. A semi-finished product of elastomeric material, comprising:
a strip;
wherein the strip is suitable for manufacturing an inner gas-impermeable coating layer of a pneumatic tyre, and
wherein a right cross-section of the strip comprises a profile that tapers axially outwards on at least one edge of the strip.

16. The semi-finished product of claim 15, wherein the right cross-section comprises a trapezoidal profile.

17. The semi-finished product of claim 16, wherein the trapezoidal profile is symmetrical with respect to a center of the right cross-section.

18. The semi-finished product of claim 16, wherein a larger base of the trapezoidal profile comprises a dimension greater than or equal to 10 mm and less than or equal to 25 mm.

19. The semi-finished product of claim 16, wherein a smaller base of the trapezoidal profile comprises a dimension greater than or equal to 1 mm and less than or equal to 10 mm.

20. The semi-finished product of claim 15, wherein a thickness of the strip is greater than or equal to 0.6 mm and less than or equal to 3.0 mm.

21. A tubeless tyre for a vehicle, comprising:
a liner layer;
wherein the liner layer is manufactured using a semi-finished product of elastomeric material comprising a strip,
wherein the strip is suitable for manufacturing an inner gas-impermeable coating layer of the tyre, and
wherein a right cross-section of the strip comprises a profile that tapers axially outwards on at least one edge of the strip.

22. A tubeless tyre for a vehicle, comprising:
a layer of liner;
wherein the layer of liner is formed by laying at least one strip of elastomeric material on a rigid support in axially consecutive turns,
wherein the at least one strip comprises a right cross section comprising a profile that tapers axially outwards on at least one edge of the at least one strip, and
wherein a tapered portion of a first turn is axially overlapped on an axially adjacent turn that was previously laid on the rigid support.
